(19) United States
(12) Patent Application Publication
(10) Pub. No.: US 2015/0293918 A1
(43) Pub. Date: Oct. 15, 2015

(54) Web Searching Software Promoting Results Of Websites Formatted For Mobile Devices

(71) Applicant: Wesley W. Whitmyer, Jr., Stamford, CT (US)

(72) Inventor: Wesley W. Whitmyer, Jr., Stamford, CT (US)

(21) Appl. No.: 14/251,128

(22) Filed: Apr. 11, 2014

(51) Int. Cl. G06F 17/30; G06F 17/21; G06Q 30/02

(52) U.S. Cl. CPC G06F 17/3053; G06F 17/30864; G06Q 30/0277; G06F 17/214

(57) ABSTRACT

A system for promoting results of websites formatted for mobile devices including a processor, software executing on the processor receiving a search term via a communications network from a mobile device, software executing on the processor identifying a plurality of websites responsive to the search term, software executing on the processor determining a mobile compatibility of each of the plurality of websites, software executing on the processor generating and presenting, via the communications network to a user interface of the mobile device, a list of at least a portion of the plurality of websites ranked at least in part according to the mobile compatibility of each of the plurality of websites.

### FIELD OF THE INVENTION

The invention relates to a system for performing Internet searches, and more specifically to a system for promoting search results of websites formatted for mobile devices.

### BACKGROUND OF THE INVENTION

With the rise of the Internet over the last years, computer software programmers have reoriented their efforts from applications loaded via the operating system onto desktop computers toward web sites and applications hosted “in the cloud” on web and server computers accessible by users from any operating system environment that includes a “browser”. Desktop applications were operating system specific, while cloud applications had the advantage of usability across operating system platforms.

While these programming changes were proceeding, changes were also under way in the computer hardware field. Mobile computing devices, so called “cellular phones”, originally used mainly for voice communication, were adding ever more computer-like features. To voice communication was added text communication functions. Close behind came web browsing functions as more sophisticated screens were added to mobile phones.

Early web browsing on mobile devices was not an entirely satisfactory user experience because, for example, the size and resolution of average desktop display screens had increased just as rapidly as mobile devices evolved. By the time mobile devices added web browsing capability, the average website was designed for use on a large desktop monitor and therefore was somewhat awkward to use on the small screen of a mobile device. To accommodate this problem and also take advantage of functionality available on mobile devices, such as a user's location, but likely not either available or changeable on desktop computing devices, software programmers again refocused their efforts away from web programming toward so-called “apps”, which are operating environment-specific software programs designed to be loaded and used on a mobile device as though it were a desktop computer.

These “apps” have all the same limitations as desktop computer application software: they have to be installed to the operating environment even for a single use, a different version of the “app” has to be written for each different mobile system, users have to do the installing and upgrading of each of their apps, and programmers have to maintain apps for each different operating environment.

There are numerous disadvantages to this system for users of mobile computing devices in addition to those mentioned above. The screen and memory of the mobile device can only accommodate a finite number of apps, so users need to delete apps that are seldom used. Users as required to download and install apps even if they only intend to use the app a single time. Exacerbating these problems is that websites have become of much less value to mobile users. Because websites can detect that a visiting user is using a mobile platform, the website owner can redirect the mobile user's browser to an advertisement imploring them to download the website's app. Browsing the Internet from a mobile computing device has accordingly become increasingly frustrating. The user is either redirected to an advertisement for the website's app, or is left to struggle with using a website designed for use on a large desktop monitor.

It is therefore desired to provide a system with an improved mobile experience for searching the Internet.

### SUMMARY OF THE INVENTION

It is therefore an object of the invention to provide a web searching software that prioritizes web search results for websites that are designed to be used on mobile devices. Another object of the invention is to provide web searching software that prioritizes web search results for websites that are more usable on small screen computing devices. A further object is to provide web search software that permits results to be prioritized based on the design of the website. Yet another object of the invention is to provide web searching software meeting one or more of the above objects, which is distributed as an app for mobile computing devices. Yet a further object of the invention is to provide web search meeting one or more of the above objects which software also includes a user-settable option for prioritizing web search results based on the format and/or design of the website.

These and other objectives are achieved by providing a system or machine for promoting results of websites formatted for mobile devices including a processor, software executing on the processor receiving a search term from a mobile device, and software executing on the processor identifying a plurality of websites responsive to the search term, e.g., from a plurality of web servers in communication with the processor. The system further includes software executing on the processor determining a mobile compatibility of each of the plurality of websites, and software executing on the processor generating and presenting, via a user interface of the mobile device, a list of at least a portion of the plurality of websites ranked at least in part according to the mobile compatibility of each of the plurality of websites. The list of the at least a portion of the plurality of websites may further be ranked according to a relevancy of each of the plurality of websites to the search term and/or according to a device type of the mobile device.

In some embodiments, the processor resides on a server remote to the mobile device, and the search term is received via a communications network from a mobile browser executing on the mobile device. Further, the software generating and presenting the list may present the list, via the communications network, to the mobile browser executing on the mobile device.

In some embodiments, the mobile compatibility is determined according to size of graphical elements in the website, font size and font type in the website, or layout of the website. The mobile compatibility may also be determined according to a programming language of the website. In some embodiments, the mobile compatibility is also determined according to a screen resolution of the website and/or according to whether the website includes pop-ups.

Other objects of the present invention are achieved by provision of a system or machine for promoting results of websites formatted for mobile devices, including a search module executing on a processor receiving, via a communications network, a search term from a mobile browser of a mobile device and identifying a plurality of websites responsive to the search term, the search module further identifying a device type of the mobile device, and a prioritization module executing on the processor determining compatibility of each of the plurality of websites with the device type, and generating and sending, via the communications network to the mobile device, a list of at least a portion of the plurality of websites ranked at least in part according to the compatibility of each of the plurality of websites and relevancy of each of the plurality of websites to the search term.

Further provided is a method or process for promoting results of websites formatted for mobile devices, including the steps of receiving, via software executing on a processor, a search query via a communications network from a mobile device, such as from a mobile browser executing on the mobile device, and searching, via software executing on the processor, a plurality of web servers to identify websites responsive to the search query. The method further includes identifying, via software executing on the processor, a level of compatibility of the websites responsive to the search query for display on the mobile device, and presenting, via the communications network to a user interface on the mobile device, a list of the websites responsive to the query in an order based at least in part on the level of compatibility of the websites for display on the mobile device.

Other objects of the present invention are achieved by provision of a mobile browser executing on a mobile device receiving input of a search term from a user and transmitting the search term to a web server via the Internet. The mobile browser further receiving prioritized search results from the web server for display on a user interface of the mobile device, the prioritized search results including at least a portion of a plurality of websites responsive to the search term ranked at least in part according to a level of compatibility of each of the websites for display on the mobile device.

Other objects of the invention and its particular features and advantages will become more apparent from consideration of the following drawings and accompanying detailed description.

### BRIEF DESCRIPTION OF THE DRAWINGS

FIG. 1 illustrates a system according to an exemplary embodiment of the present invention.

FIG. 2 illustrates software on a processor of the system shown in FIG. 1.

FIG. 3 illustrates a prioritization module of the system shown in FIG. 1.

FIGS. 4A-4B illustrates a mobile device of the system shown in FIG. 1.

FIG. 5 illustrates a method according to an exemplary embodiment of the present invention.

### DETAILED DESCRIPTION OF THE INVENTION

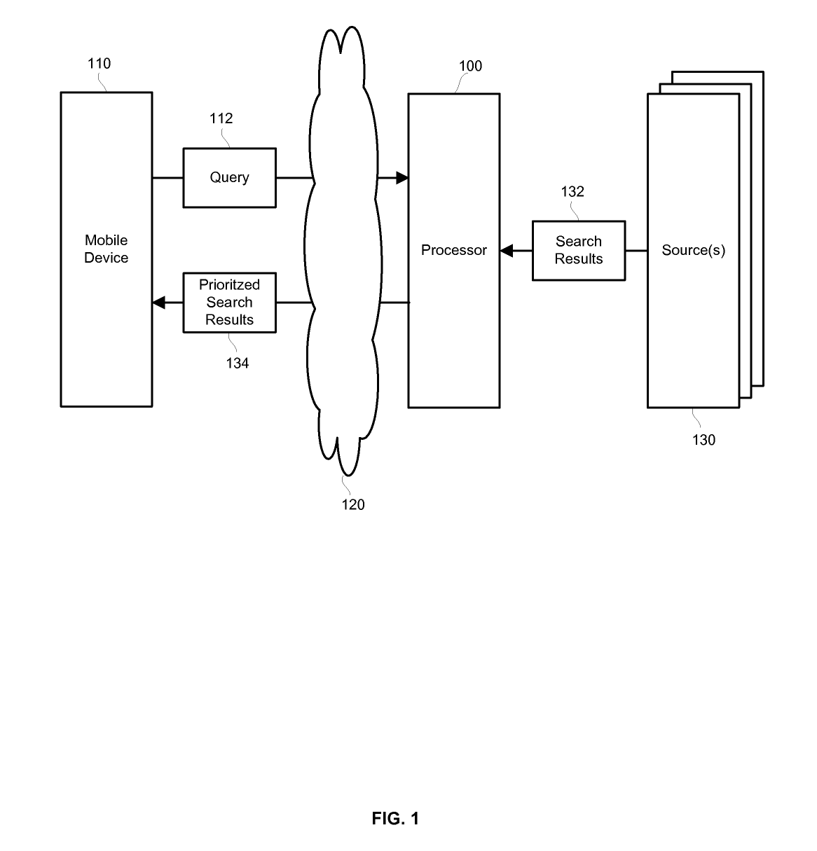

FIG. 1 shows a system according to an exemplary embodiment of the present invention. The system includes a processor 100, embodied in hardware, in communication with a mobile device 110 via a communications network 120, such as the Internet or a local area network. The processor 100 may be comprised in a computer or server. The mobile device 110 (e.g., smart phone) preferably includes a display, a processor, and a data input device such as a touch screen (e.g., 114), keyboard (e.g., 115), and/or microphone with voice recognition. The data input device may be housed within the mobile device 110 or an external device (e.g., connected via Bluetooth). The system further includes a plurality of sources 130, such as web servers, e.g., which store and host websites, and/or source databases containing the websites and website pages or information.

The mobile device 110 sends a query 112 to the processor 100, e.g., including one or more search terms. The query 112 may be text entered into the mobile device 110 by a user of the mobile device 110 executing on the mobile device 110 using the input device of the mobile device 110. The query 112 is preferably entered into a mobile browser executing on the mobile device 110; however a mobile application could be used in some embodiments. In particular, the system may include software executing on the processor 100 (and/or a processor on the mobile device 110) for generating and displaying a mobile browser on the mobile device 110. The processor 110, using software executing thereon, electronically searches for and identifies search results 132 responsive to the query 112. In particular, the processor 110 may search any number of the sources 130 for responsive search results 132, such as websites.

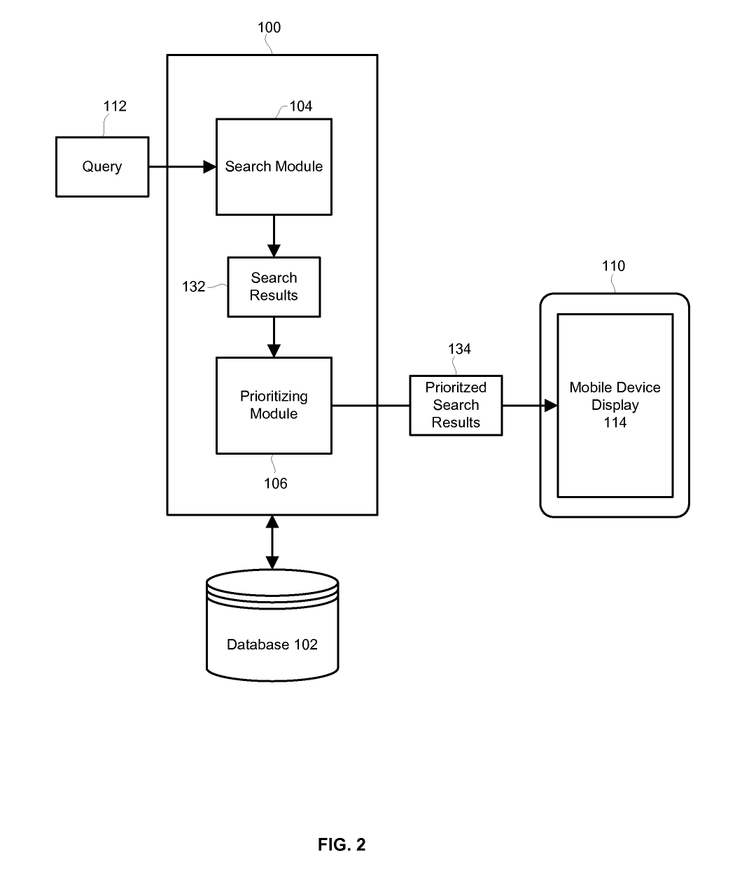

FIG. 2 shows a portion of the system of FIG. 1 including the processor 100 and the mobile device 110. The processor 100 includes software executing thereon, e.g., and stored in a database 102 in communication with the processor 100. The software includes a search module 104 receiving the query 112 (e.g., via the communications network 120) from the mobile device 110. In particular, the search module 104 may receive the query from a mobile browser on the mobile device 110. The received query 112 may include, e.g., one or more search terms. The search module 104 queries the sources 130 to identify and receive search results 132 responsive to the query 112.

Software executing on the processor 100 further includes a prioritizing or ranking module 106. The prioritizing module 106 analyzes the search results 132 to determine a mobile compatibility of each of (or at least a portion of) the search results 132. For example, the processor 100 and/or software executing thereon may receive or obtain information about the search results 132, such as the programming language comprised in a website search result (e.g., XHTML-MP (Mobile Profile), WCSS (Wireless Cascading Style Sheets), and/or HTML5) and/or lack of interactive programming (e.g., Flash and/or JavaScript), and use this information to determine mobile compatibility.

Other factors used to determine mobile compatibility may include, but are not limited to, the size of graphical elements in the website, font size or font type in the website, the design or layout of the website, size (length and/or width, number of columns, etc.) of the website, the screen resolution of the website, placement or type of buttons or inputs, and/or whether the website includes pop-ups. The factors may also include the data size and/or load speed of the website or specific pages of the website. The factors may also include the number of (and/or placement of) input fields required by the website (e.g., for user registration purposes or otherwise), as it may be cumbersome to enter a significant amount of information into the website using the mobile device. Further, the factors may include meta tags embedded in the website indentifying its mobile compatibility and/or the identification of whether the website includes a distinct mobile version.

The mobile compatibility may be evaluated by any number of different means. For example, the system may assign a value or rank to each of a plurality of the factors and total the values to obtain an overall score that is compared to the scores of each other website in the search results 132. In some embodiments, the system may receive user ratings of the mobile compatibility of various websites from users of the system and use such user ratings to rank mobile compatibility of the websites in the search results 132. In some instances, the prioritizing module 106 may obtain data stored by the processor (e.g., in the database 102) identifying the mobile compatibility of a particular website from a previous search. In such cases, the system may check the version or date of the website to confirm that it has not been updated or changed since the last analysis.

In some embodiments, the prioritizing module 106 or other software executing on the processor 100 determines mobile compatibility based at least in part on the particular features of the mobile device 110 from which the query 112 is received. For example, the system may obtain information about the mobile device 110 including the manufacturer and model, display size, operating system (e.g., iOS, Android, etc.), browser type, and/or processing speed and use this information as a factor for mobile compatibility. The system may also analyze and use status information (e.g., battery life, signal strength, etc.) and user specific settings (e.g., settings restricting certain types of websites or website features) from the device to determine mobile compatibility.

The prioritizing module 106 then ranks or orders the results 132 into a list of prioritized search results 134 which is sent to and displayed on a display 114 of the mobile device 110. The prioritized search results 134, or the mobile compatibility of the websites therein, may also be stored in the database 102. The user of the mobile device 110 receives the visual display of the prioritized search results 134 on the display 114, e.g., in a mobile browser. Using the input device (e.g., touch screen display 114 or keyboard 115), the user may click on any one of the results 134 to open an associated website in a mobile browser.

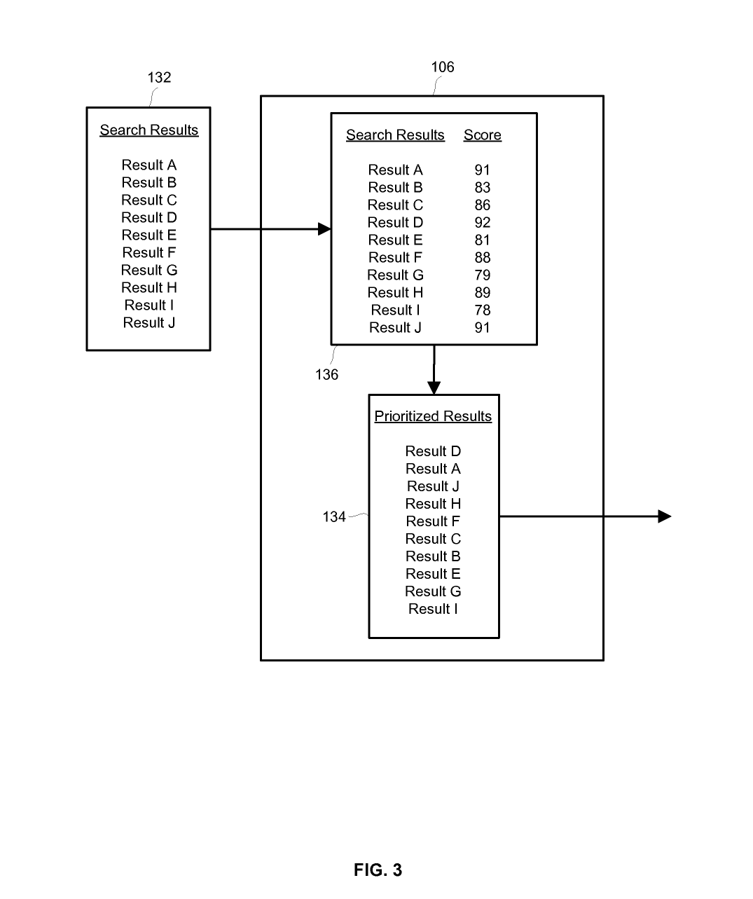

FIG. 3 shows another portion of the system of FIG. 1 including the prioritizing module 106. The prioritizing module 106 analyzes the search results 132, determines mobile compatibility, and ranks or scores the results based on the mobile compatibility. For example, the prioritizing module 104 may generate score data 136 for each of search results and list the results according to their score. The score data 136 may be stored in the database 102.

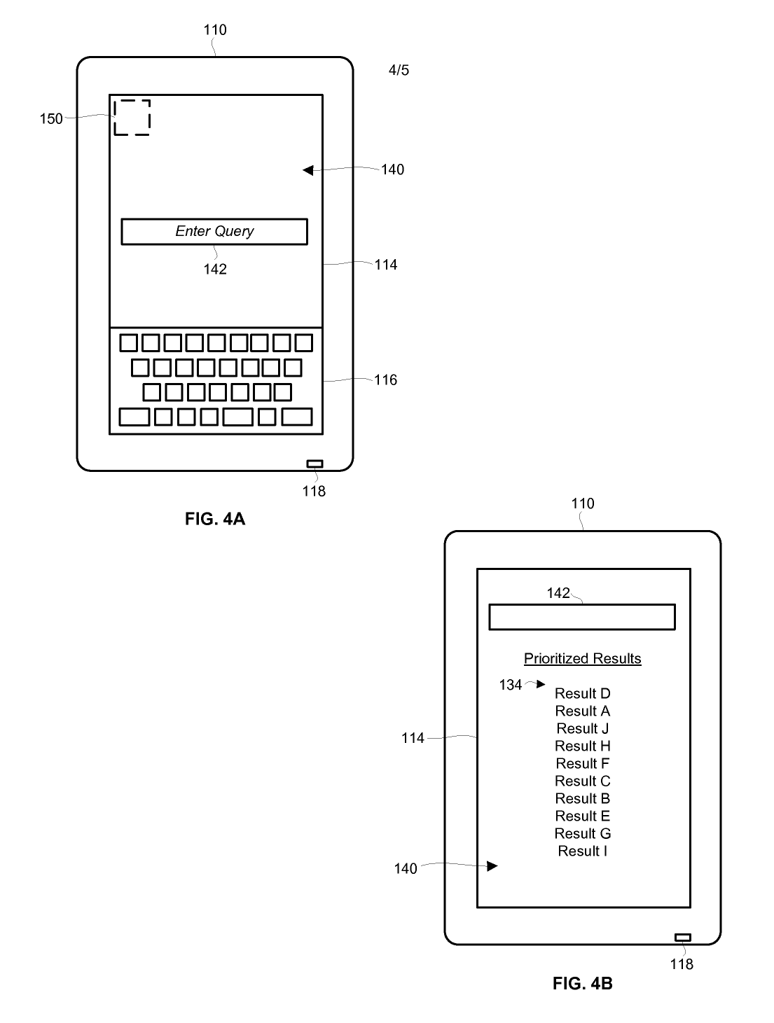

FIGS. 4A-4B shows an example of a mobile device 110 used in the system of FIG. 1. The mobile device 110 may be a phone, smart phone, tablet or other wireless mobile device communicative via a communications network, such as the Internet. While the above description of the invention pertains primarily to mobile devices, such as smart phones, some embodiments of the invention may also be practiced with computers, such as lap top computers and/or netbooks, having limited screen size and/or capability (e.g., operating system, software, etc.) to view standard websites.

The mobile device 110 includes the display or user interface 114 which presents a mobile browser 140 to the user. The browser 140 includes a search field 142 for receiving a query, such as one or more text search terms. The mobile device 110 further includes one or more input devices, such as a touch screen 114, keyboard 116, and/or a microphone 118. Upon the system executing the search and prioritization of results, prioritized results 134 are received by the mobile device 110 and displayed to the user in the browser 140 (e.g., as hyperlinks). As one of ordinary skill in the art will understand, the browser 140 may display information about the results to assist the user in selection, such as website names, URLs, summaries of content, and/or website previews. The user of the mobile device 110 may click on any one of the prioritized results 134 to open the associated website in a browser 140.

The mobile device 110 further includes a processor 150 within the mobile device 110. The processor 150 may execute software to display the mobile browser 140 and execute functions on the mobile device 110. While the system is described herein as employing a processor 100 separate from (e.g., on a server) and in communication with the mobile device 110 to execute the software, in some embodiments the software may reside solely on the mobile device 110 and execute using the processor 150 therein. In other embodiments, the software may reside partially on the mobile device 110 such that some of the software (e.g., for searching and prioritizing, etc.) executes on the processor 100 while other software (e.g., for displaying the results, etc.) executes on the processor 150.

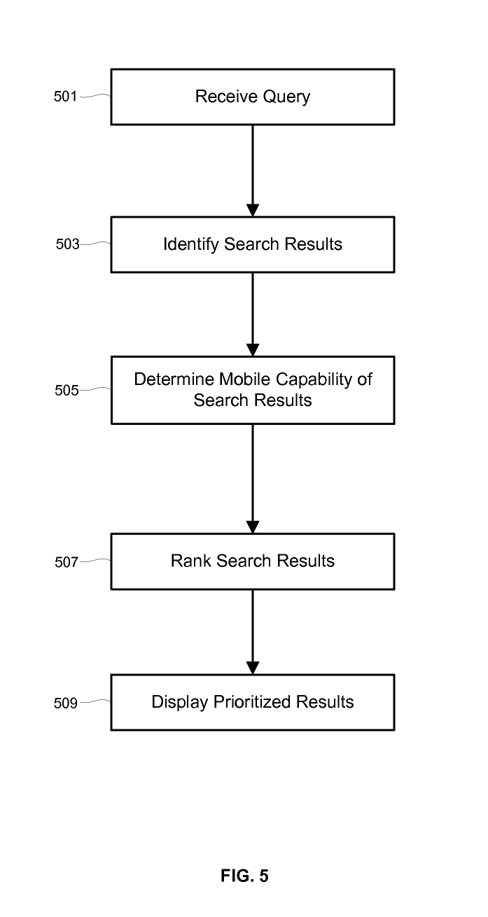

FIG. 5 shows a method according to an exemplary embodiment of the present invention. The method includes the steps of receiving a query (501), identifying search results (503), determining mobile compatibility of the search results (505), and ranking or ordering the search results (507). The ranking or ordering is based on the mobile compatibility, but may also be based on the relevance of a website to the query and/or the type or features of the mobile device which will be receiving the prioritized search results. The prioritized search results are then sent to and displayed on the mobile device (509).

The method is carried out on a computer and/or processor programmed to perform the steps of the method. In particular, the method may be carried out on a processor residing on a server in communication with mobile devices via a communications network. In other embodiments, the method may be carried out on a processor residing on the mobile device itself. The method may also be carried out in a mobile browser.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for promoting results of websites formatted for mobile devices, comprising:
a processor;
software executing on said processor receiving a search term from a mobile device;
software executing on said processor identifying a plurality of websites responsive to the search term;
software executing on said processor determining a mobile compatibility of each of the plurality of websites;
software executing on said processor generating and presenting, via a user interface of the mobile device, a list of at least a portion of the plurality of websites ranked at least in part according to the mobile compatibility of each of the plurality of websites.

2. The system according to claim 1, wherein said processor resides on a server remote to the mobile device, and wherein the search term is received via a communications network from a mobile browser executing on the mobile device.

3. The system according to claim 2, wherein said software generating and presenting the list presents the list, via the communications network, to the mobile browser executing on the mobile device.

4. The system according to claim 1, wherein said processor resides on the mobile device.

5. The system according to claim 1, wherein the list of the at least a portion of the plurality of websites is further ranked according to a relevancy of each of the plurality of websites to the search term.

6. The system according to claim 1, further comprising:
software executing on said processor identifying a device type of the mobile device, wherein the list of at least a portion of the plurality of websites is further ranked according to the device type.

7. The system according to claim 1, wherein the plurality of websites responsive to the search term are identified from a plurality of web servers in communication with the processor via the Internet.

8. The system according to claim 1, wherein the mobile compatibility is determined according to size of graphical elements in the website.

9. The system according to claim 1, wherein the mobile compatibility is determined according to at least one of font size and font type in the website.

10. The system according to claim 1, wherein the mobile compatibility is determined according to a programming language of the website.

11. The system according to claim 1, wherein the mobile compatibility is determined according to a layout of the website.

12. The system according to claim 1, wherein the mobile compatibility is determined according to a screen resolution of the website.

13. The system according to claim 1, wherein the mobile compatibility is determined according to whether the website includes pop-ups.

14. A system for promoting results of websites formatted for mobile devices, comprising:
a search module executing on a processor receiving, via a communications network, a search term from a mobile browser of a mobile device and identifying a plurality of websites responsive to the search term;
said search module further identifying a device type of the mobile device; and
a prioritization module executing on the processor determining compatibility of each of the plurality of websites with the device type, and generating and sending, via the communications network to the mobile device, a list of at least a portion of the plurality of websites ranked at least in part according to the compatibility of each of the plurality of websites and relevancy of each of the plurality of websites to the search term.

15. The system according to claim 14, wherein the list is displayed in the mobile browser of the mobile device.

16. The system according to claim 14, wherein the plurality of websites responsive to the search term are identified from a plurality of web servers in communication with the processor via the Internet.

17. The system according to claim 14, wherein the compatibility is determined based at least in part on size of graphical elements in the website.

18. The system according to claim 14, wherein the compatibility is determined based at least in part on at least one of font size and font type in the website.

19. The system according to claim 14, wherein the compatibility is determined based at least in part on a programming language of the website.

20. The system according to claim 14, wherein the compatibility is determined based at least in part a screen resolution of the website.

21. A method for promoting results of websites formatted for mobile devices, comprising the steps of:
receiving, via software executing on a processor, a search query via a communications network from a mobile device;
searching, via software executing on the processor, a plurality of web servers to identify websites responsive to the search query;
identifying, via software executing on the processor, a level of compatibility of the websites responsive to the search query for display on the mobile device; and
presenting, via the communications network to a user interface on the mobile device, a list of the websites responsive to the query in an order based at least in part on the level of compatibility of the websites for display on the mobile device.

22. The method according to claim 21, wherein the order of the list of the websites responsive to the query is further based on relevancy of each website to the search query.

23. The method according to claim 21, wherein the compatibility is determined according to a programming language of the website.

24. The method according to claim 21, the compatibility is determined according to a size of elements in the website.

25. The method according to claim 21, wherein the search query is received from a mobile browser executing on the mobile device.
